(19) United States
(12) Patent Application Publication
(10) Pub. No.: US 2025/0272710 A1
(43) Pub. Date: Aug. 28, 2025

(54) Method For Analyzing the Acceptance of an Offer Displayed in a Vehicle

(71) Applicant: Bayerische Motoren Werke Aktiengesellschaft, Muenchen (DE)

(72) Inventors: Manuel Schiller, Eichstätt (DE); Benjamin Krebs, Zorneding (DE)

(21) Appl. No.: 18/853,240

(22) PCT Filed: Mar. 29, 2023
(86) PCT No.: PCT/EP2023/058195

§ 371 Date: Oct. 1, 2024

(30) Foreign Application Priority Data
Apr. 14, 2022 (DE) 10 2022 109 339.5

(51) Int. Cl. G06Q 30/0242; G06Q 30/0251; H04W 4/021

(52) U.S. Cl. CPC G06Q 30/0242; G06Q 30/0266; H04W 4/021

(57) ABSTRACT

A method for analyzing whether a user of a vehicle has accepted an offer displayed in the vehicle includes determining a geoposition at which the displayed offer is or was offered. The method also includes determining a stopping behavior of the vehicle by means of in-vehicle sensors, after the offer has been displayed in the vehicle. The method further includes outputting information that the displayed offer has been accepted by the user, depending on a predetermined relationship between the determined geoposition and the determined stopping behavior.

The present application is the U.S. national phase of PCT Application PCT/EP2023/058195 filed on Mar. 29, 2023, which claims priority of German patent application No. 10 2022 109 339.5 filed on Apr. 14, 2022, the entire contents of which are incorporated herein by reference.

### TECHNICAL FIELD

The disclosure relates to vehicles, and more particularly, determining whether a user of a vehicle has accepted an offer displayed in the vehicle.

### BACKGROUND

In modern motor vehicles, infotainment are systems usually used to provide information or entertainment to the occupants. Increasingly, the possibility is also used to output advertisements, offers or advertising to the vehicle occupants. These advertisements may include, in particular, offers or content that are useful for the journey or the vehicle and may be adapted to the course of the journey.

In today's computer systems, for example, it is common practice on websites to analyze whether and how information displayed to the user has been accepted by the user (conversion tracking), for example to evaluate the efficiency and usefulness of advertisements. Conversion tracking is a process that captures what happens after a customer interacts with an advertisement. For example, one can see whether they have bought a product, signed up for a newsletter, called a company or downloaded an app. Customer actions that are considered valuable to a business can be referred to as conversions.

In the case of Internet websites, it may be easier to carry out such conversion tracking, as both the advertisement and the interaction take place in a common system, in which both the advertisement and other interactions such as payments are created.

However, if an advertisement for an external offer is output in a vehicle, it can be difficult to check whether the offer has actually been accepted, as there is sometimes no connection between the vehicle and the provider or data protection regulations do not allow such a connection. For example, it is not possible to determine whether a driver actually refueled at a particular gas station that was suggested to him in the vehicle.

There is a need, therefore, for methods for an analysis of whether an offer displayed in a vehicle was actually accepted by a vehicle user.

### SUMMARY

The above-described need, as well as others, are addressed by the subject matter of the independent patent claims. Other advantageous embodiments are described in the dependent patent claims, the following description and in connection with the figures.

Accordingly, a method is proposed for analyzing whether a user of a vehicle has accepted an offer displayed in the vehicle or not. The method includes determining a geoposition at which the displayed offer is offered and determining the stopping behavior of the vehicle by means of in-vehicle sensors after the offer has been displayed in the vehicle. Finally, information is output that the displayed offer has been accepted by the user, depending on a predetermined relationship between the determined geoposition and the determined stopping behavior. If, on the other hand, the connection between the determined geoposition and the stopping behavior indicates that the driver has not accepted the offer, corresponding information can be output that the offer has not been accepted.

The geoposition at which the offer is made can be, for example, a branch or a store of the provider. For example, corresponding advertisements can be displayed in a navigation system, which means that the position or geoposition of the offer can also be displayed directly on the map. The provider's geoposition can be in a direction of or near a planned route of the vehicle, for example.

Determining the stopping behavior may include, in particular, determining a stopping location or a GPS position of the vehicle. In addition, a stopping period can also be taken into account, such as how long the vehicle remains at the stopping location.

A connection that speaks in favor of an actual acceptance of the displayed offer may be that the vehicle stops within a predetermined distance of the determined geoposition of the offer. In particular, it can be a relationship of the stopping location of the vehicle to the determined geoposition. If, for example, it is determined that the vehicle stops at the geoposition assigned to the offer within a predetermined maximum period of time after the offer has been displayed in the vehicle, it can be assumed, for example, that the offer has been accepted. If, on the other hand, the vehicle stops too far away from this determined geoposition, the vehicle does not stop at all, or the vehicle only stops after the maximum time has elapsed (for example only after a few hours), it can be assumed that the offer was not accepted or at least was not accepted as a direct result of the displayed offer.

The output of the information can include, for example, a transmission of the information to a backend (for example an Internet server; for example an Internet server of the provider of the offer), so that the provider of the displayed offer can receive the output information. One advantage can be that the provider is able to recognize whether his advertisement was useful or not, so that, for example, a group of recipients of such advertisements can be limited better and the vehicle occupants are not shown unusable offers.

According to one aspect of the disclosure, it is provided that a geofence associated with the determined geoposition is provided. The geofence can be, for example, radius or area around the determined geoposition a (radius size, for example depending on the displayed offers). In the case of a gas station, the geofence can be the floor area of the gas station, in the case of a restaurant, the parking spaces of the restaurant or a defined radius around the restaurant (for example a radius of less than 500 m or less than 300 m or less than 100 m). Determining the stopping behavior includes a check as to whether the vehicle stops within the geofence. The stopping behavior can be detected, for example, by means of a position sensor or a GPS sensor of the vehicle or, alternatively, by means of camera images of the vehicle, for example whether a business sign of the provider can be seen on the camera image (for example a gas station logo or the logo of the provider). Whether the information is output that the user has accepted the displayed offer depends accordingly on whether (and for example for how long) the vehicle stops within the geofence (for example as a connection between the determined geoposition and the stopping behavior).

According to one aspect, it is envisaged that outputting the information that the user has accepted the displayed offer will only take place if the vehicle stops within the geofence for a predetermined minimum period of time. This predetermined minimum period depends in particular on the nature of the offer. According to one aspect, it is provided accordingly that the predetermined minimum duration is chosen depending on the displayed offer. For example, the minimum length of time may be shorter for an offer from a gas station than for an offer from a restaurant, as customers usually stay there for a shorter period of time. For example, the minimum time at a gas station can be a typical time that is needed at least for refueling and paying. For example, a longer period of time can be chosen for a restaurant than for a snack bar. Including a stopping period in the stopping behavior can make it possible to improve the analysis result, for example to be able to assess more precisely whether the offer was actually accepted or not.

According to one aspect, it is envisaged that the displayed offer is a vehicle-related offer and includes the determination of the stopping behavior, to evaluate by means of the internal sensors of the vehicle whether an offer-dependent change in the vehicle condition has taken place within a predetermined proximity to the determined geoposition. The internal sensors of the vehicle can be a position sensor or GPS sensor, which enables a comparison of the location of the vehicle with the location corresponding to the offer (for example the determined geoposition). However, other vehicle sensors can enable a more precise analysis of the stopping behavior, for example a vehicle camera (internal or external). Depending on the type of offer displayed, it may be advantageous to use specific vehicle sensors to determine the stopping behavior, as will also be explained in more detail below.

According to one aspect, it is envisaged that the displayed offer concerns a display of a gas station or charging station and is evaluated by the internal sensors of the vehicle to determine whether a fuel cap or a charging flap is operated when the vehicle is stopped and/or whether the fill level of the tank rises or the state of charge of the vehicle battery increases. Accordingly, the internal sensors of the vehicle can be a level indicator or a voltage measuring device. If, after stopping the vehicle at the position of a gas station or charging station, the level of the tank or the state of charge is higher than before it was stopped, it is very likely, for example, that the vehicle has refueled or charged at this gas station or charging station.

According to one aspect, it is envisaged that the displayed offer concerns a display of a car wash and that the internal sensors of the vehicle evaluate whether the vehicle has entered a car wash (for example by means of a camera), whether a vehicle moisture sensor detects moisture on the vehicle, or whether a vehicle car wash mode has been activated. For example, the car wash mode can include retracting the wing mirrors and setting the gearbox to idle, which may be necessary to use a car wash. In the case of the internal sensors of the vehicle, the humidity sensor can be highlighted as offer-specific, since at the position of a car wash, for example, the vehicle can only get wet when this car wash is actually used and can be dry again after a short time (for example in contrast to sudden rain).

According to one aspect, it is envisaged that the displayed offer concerns an advertisement of a shop and that the internal sensors of the vehicle evaluate whether purchases are loaded into the vehicle when the vehicle is stopped, a shopping trolley is detected next to the vehicle, or a logo of the shop is recognized by a vehicle camera. For example, the determination of the stopping behavior can include a detection of an opening of a door or tailgate in connection with a recognition of shopping bags, in particular with the logo of the shop. If shopping bags from the provider are loaded after a certain stopping period, it can very probably be assumed that the vehicle occupant has shopped in the shop.

According to one aspect, as already mentioned, it is envisaged that determining the stopping behavior of the vehicle includes the use of a vehicle camera and/or a position sensor. For example, it can be an interior and/or exterior camera of the vehicle.

In particular, the joint use of vehicle camera and position sensor (and for example also time measurement) can enable a particularly reliable analysis result.

Another aspect concerns a vehicle with an output option for displaying offers, wherein the vehicle has a sensor system for determining the stopping behavior of the vehicle. It is also envisaged that the vehicle is equipped with a control device that is designed to carry out a method described above or below for analyzing the acceptance of a displayed offer. One advantage of such a vehicle can be that providers that have offers displayed in the vehicle can get feedback as to whether the offer was suitable for the vehicle occupants and was therefore accepted or whether this is not the case. For the vehicle occupants, this can result in the advantage that over time they can be shown more suitable offers that also bring them real added value.

Examples refer to a computer program that has a program code for performing a disclosed method when the computer program is executed on a processor, a computer or programmable hardware. Such a computer program can advantageously be provided and executed in a vehicle or a control unit of a vehicle.

### BRIEF DESCRIPTION OF THE DRAWINGS

Exemplary embodiments are explained in more detail below with reference to the enclosed figures. In the figures:

FIG. 1 shows a flowchart of a method

FIG. 2 shows a schematic example where an offer is displayed that is accepted by a user; and

FIG. 3 shows a schematic example where an offer is displayed that is not accepted by a user.

### DESCRIPTION

Various exemplary embodiments are now described in more detail with reference to the enclosed drawings, in which some exemplary embodiments are shown. In the figures, the thickness dimensions of lines, layers and/or regions may be exaggerated for the sake of clarity. In the following description of the enclosed figures, which only show a few exemplary embodiments, the same reference signs can denote the same or comparable components.

An element that is said to be “connected” or “coupled” to another element may be directly connected or coupled to the other element, or intermediate elements may be present. Unless otherwise defined, all terms used herein (including technical and scientific terms) shall have the same meaning as those given to them by an average person skilled in the art in the field to which the exemplary embodiments belong.

FIG. 1 shows a flowchart of a method 10. The method 10 makes it possible to analyze whether a user of a vehicle has actually accepted an offer displayed in the vehicle or not. The method 10 includes a determination 11 of a geoposition at which the displayed offer is offered as well as a determination 12 of a stopping behavior of the vehicle by means of in-vehicle sensors after the offer has been displayed in the vehicle. It is also envisaged to output information 13 that the displayed offer has been accepted by the user. Outputting 13 the information depends on a predetermined relationship between the determined geoposition and the determined stopping behavior.

In particular, it is envisaged that in the event of a stop of the vehicle at the determined geoposition or in a predetermined proximity to the geoposition, the information that the user has accepted the offer is output. If a driver drives to the location of the offer after the offer has been notified and stops there, it can be assumed, for example, with sufficient probability that the driver has actually used the offer.

In this way, it is advantageously possible to determine whether or not offers displayed in the vehicle are accepted by the driver.

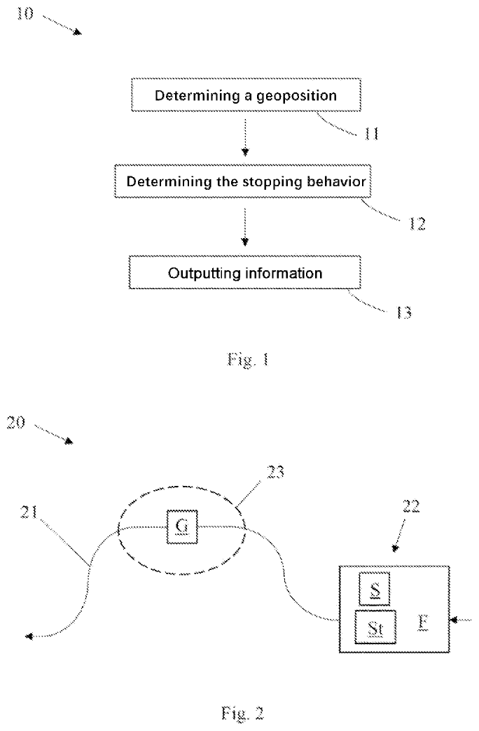

FIG. 2 shows a schematic example 20 of a display of an offer that is accepted by a user. A vehicle F has a sensor S, which is designed to determine a location of the vehicle F (for example a GPS sensor). There is also a control device St which can, for example, control a display of the offer and/or can carry out the proposed method. The display of the offer can be done visually or acoustically, for example.

In the example 20 shown, the vehicle F is driving on a vehicle trajectory 21. At a first point in time, the vehicle F is located at a first geoposition 22. There, for example, the offer can be displayed in the vehicle, wherein the location at which the offer can be accepted is at geoposition G (for example the location of a gas station). For example, a geofence 23 (for example the site or property of the gas station) is defined around the geoposition G.

Now, during the journey, it can be detected by the vehicle F that vehicle trajectory 21 leads through the geofence 23 and to the geoposition G. For example, it can also be determined that the vehicle F stops within the geofence 23. With regard to the details of the stopping behavior of the vehicle F, a stopping period can also be included, for example. If, for example, the stopping period is typical for the length of stay at the location of the offer (for example refueling time and payment time at a gas station), then it can be assumed that the displayed offer was accepted by the driver. Consequently, the information can be output 13 that the offer has been accepted. This can advantageously help assess the effectiveness of advertisements.

As explained using FIG. 2, in this disclosure it is proposed to use conversion tracking of vehicle-related services or products advertised or displayed in the vehicle with the help of vehicle sensors. Thus, for example, a direct connection is not required between the vehicle and the provider during conversion tracking.

The solution for the example of refueling (for example advertisement and offer of a gas station) is explained below. Analogous approaches can also be implemented for other vehicle-related services or products such as charging, parking, car wash, but also extended services such as drive-through food or take-away fast food, but also shopping at a supermarket.

While the vehicle F is in motion, advertising for a gas station, (for example a gas station at geoposition G), is displayed, for example in the navigation system in the vehicle. The driver may interact with this advertisement and adopt the gas station as a new intermediate destination in his planned route. Alternatively, the customer sees the advertisement and drives to the gas station, but without including it in his route. In this case, too, it can be determined according to the method whether the driver actually uses the offer of the gas station or not.

For example, the vehicle is now parked at the gas station (or within the geofence 23). Now, with the help of the evaluation of the vehicle sensors, it can be determined whether the driver has actually refueled at this gas station (for example determining the stopping behavior). For this purpose, one or more of the following signals or information can be evaluated, for example: the geoposition or trajectory of the vehicle (for example by means of a position sensor); whether the vehicle has entered a geofence defined around the gas station; how long the vehicle has been parked there; whether the fuel cap has been opened (for example by means of a fuel cap sensor, which detects whether the fuel cap is open or closed); whether the fuel level is higher when driving off (again) than when arriving; whether a gas pump nozzle has been inserted into the tank (for example detection with the help of a camera that detects the surroundings of the vehicle); whether the driver or another passenger has disembarked (for example using seat occupancy sensors).

By linking these signals, it is now possible, for example with the help of a rule-based system, to determine whether or not refueling was carried out at this gas station. Alternatively or additionally, a model trained with the help of machine learning can also be used. This model can be trained and improved by asking the driver whether he has refueled or not. The signals can be evaluated in the vehicle or in a backend system.

Other examples show the application of the method 10 and details for other possible types of offer. For example, the following can also be used to detect the use of a car wash: detect whether the vehicle has entered a car wash on the basis of camera images that record the surroundings of the vehicle; moisture sensor; manual activation of a “car wash mode” by the driver.

For example, the following can also be used to detect shopping at a supermarket: length of time, how long the vehicle has been parked in the supermarket parking lot; whether purchases have been loaded into the vehicle (for example detection with the help of the interior camera), or whether a logo of the supermarket is recognizable on these purchases; whether the driver has approached the vehicle with a shopping cart (for example detection with the help of a camera that records the surroundings of the vehicle); whether the tailgate has been opened and something has been loaded in.

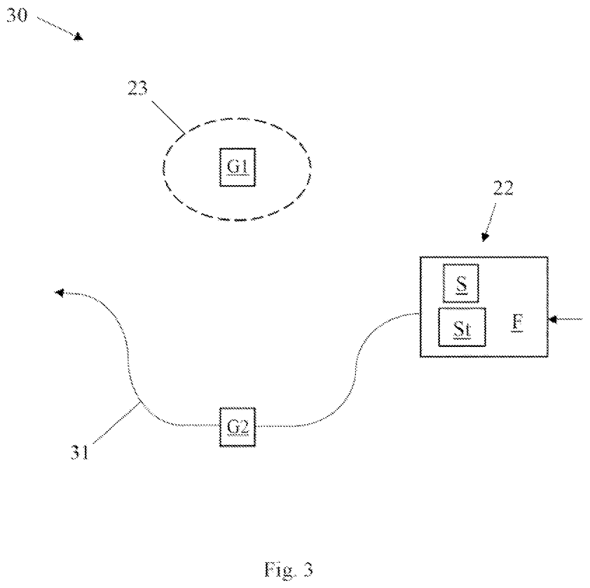

Further details and aspects are mentioned in connection with the exemplary embodiments described above or below. The exemplary embodiment shown in FIG. 2 may have one or more optional additional features corresponding to one or more aspects mentioned in connection with the proposed concept or with one or more embodiments described above (for example FIG. 1) or below (for example FIG. 3).

FIG. 3 shows a schematic example 30 of an advertisement of an offer that is not accepted by a user. As in FIG. 2, the driver at geoposition 22 can be shown an offer that is associated with a geoposition G1 (for example first gas station). The vehicle F can now analyze the further course of the journey. For example, a trajectory 31 can lead away from the geoposition G1 and the geofence 23. Thus, it can be determined that the vehicle F did not drive through the geofence 23 and that the offer was therefore not accepted by the driver.

Furthermore, it can be determined, for example, that the vehicle trajectory 31, on the other hand, runs along geoposition G2 (for example location of a second gas station). If the stopping behavior of the vehicle F indicates that the driver has stopped at the second geoposition G2 (and it is determined that he has refueled there, for example), information can be output that although the offer actually displayed has not been accepted, example an alternative offer similar to this offer has been accepted. This can also be helpful for improving the display of offers.

Further details and aspects are mentioned in connection with the exemplary embodiments mentioned above or below. The exemplary embodiment shown in FIG. 3 may have one or more optional additional features corresponding to one or more aspects mentioned in connection with the proposed concept or with one or more exemplary embodiments described above (for example FIGS. 1-2) or below.

Examples refer to a method for the conversion tracking of vehicle-related services/products advertised in the vehicle. Tracking in online advertising in the browser can be done by means of cookies. If, on the other hand, vehicle-related services such as refueling and washing are advertised at a certain location in the vehicle navigation system, it may also be necessary to track or check whether the driver has followed the advertisement and used the service (referred to as “conversion tracking”). However, no since there is usually relationship or connection between the payment process on site (for example of the offer) and the advertising displayed in the vehicle (for example there is no overarching cookie between the advertising system and the payment system), it is not possible to achieve consistency of tracking according to other concepts. The proposed method can advantageously make it possible to provide such tracking and thus, for example, to better analyze the effectiveness of displays or advertisements.

1.-10. (canceled)

11. A method for analyzing whether a user of a vehicle has accepted an offer displayed in the vehicle, the method comprising:
determining a geoposition at which the displayed offer is or was offered;
determining a stopping behavior of the vehicle by means of in-vehicle sensors, after the offer has been displayed in the vehicle; and
outputting information that the displayed offer has been accepted by the user, depending on a predetermined relationship between the determined geoposition and the determined stopping behavior.

12. The method as claimed in claim 11, wherein:
a geofence associated with the determined geoposition is provided;
determining the stopping behavior includes a check as to whether the vehicle stops within the geofence, and
outputting the information that the user has accepted the displayed offer depends on whether the vehicle stops within the geofence.

13. The method as claimed in claim 12, wherein determining the stopping behavior of the vehicle further includes using at least one of the group consisting of a vehicle camera and a position sensor.

14. The method as claimed in claim 12,
wherein outputting the information that the user has accepted the displayed offer takes place depending on whether the vehicle stops for a predetermined minimum duration within the geofence.

15. The method as claimed in claim 14,
wherein the predetermined minimum duration is chosen depending on the displayed offer.

16. The method as claimed in claim 11, wherein:
the displayed offer is a vehicle-related offer; and
determining the stopping behavior includes evaluation using the in-vehicle sensors of whether an offer-dependent change in the vehicle condition has taken place within a predetermined proximity to the determined geoposition.

17. The method as claimed in claim 16, wherein determining the stopping behavior of the vehicle further includes using at least one of the group consisting of a vehicle camera and a position sensor.

18. The method as claimed in claim 16, wherein:
the displayed offer relates to a display of a gas station or charging station; and
the evaluation using the in-vehicle sensors includes evaluating whether a fuel filler cap or a charging flap is operated when the vehicle is stopped.

19. The method as claimed in claim 16, wherein:
the displayed offer relates to a display of a gas station or charging station; and
the evaluation using the in-vehicle sensors includes evaluating whether a fuel level of a fuel tank rises or a state of charge of a vehicle battery increases.

20. The method as claimed in claim 16, wherein:
the displayed offer relates to a display of a car wash; and
the evaluation using the in-vehicle sensors includes evaluating whether the vehicle has entered a car wash, or whether a moisture sensor of the vehicle detects moisture on the vehicle, or whether a car wash mode of the vehicle has been activated.

21. The method as claimed in claim 11, wherein:
the displayed offer relates to an advertisement of a shop; and
determining the stopping behavior includes evaluation using the in-vehicle sensors of a duration of a stop.

22. The method as claimed in claim 11, wherein:
the displayed offer relates to an advertisement of a shop; and
determining the stopping behavior includes evaluation using the in-vehicle sensors to determine whether purchases are loaded into the vehicle when the vehicle is stopped, a shopping trolley is detected next to the vehicle, or a logo of the shop is recognized by a vehicle camera.

23. The method as claimed in claim 11, wherein determining the stopping behavior of the vehicle includes using a vehicle camera.

24. The method as claimed in claim 11, wherein determining the stopping behavior of the vehicle includes using a position sensor.

25. The method as claimed in claim 11, wherein:
determining the stopping behavior of the vehicle further includes using at least one of the group consisting of a vehicle camera and a position sensor; and
determining the stopping behavior further includes evaluation using the in-vehicle sensors of a duration of a stop.

26. A vehicle with an output option for displaying offers, wherein the vehicle has a sensor system configured to for determine a stopping behavior of the vehicle, and wherein the vehicle also has a control device which is configured to carry out the method as claimed in claim 11.
